(19) United States
(12) Patent Application Publication
(10) Pub. No.: US 2016/0206133 A1
(43) Pub. Date: Jul. 21, 2016

(54) Brewing Material Container

(71) Applicant: ARM Enterprises, Whittier, CA (US)

(72) Inventor: Adrian Rivera, Whittier, CA (US)

(21) Appl. No.: 15/058,011

(22) Filed: Mar. 1, 2016

Related U.S. Application Data
(63) Continuation-in-part of application No. 13/436,667, filed on Mar. 30, 2012, now Pat. No. 9,271,597.

(51) Int. Cl. A47J 31/06

(52) U.S. Cl. CPC A47J 31/06

(57) ABSTRACT

A container is configured to hold brewing material while brewed by a beverage brewer and includes a receptacle configured to receive and support the brewing material, and a cover. The receptacle includes a base, a sidewall, and an open top. The base and/or sidewall has an aperture that allows fluid communication from an interior to an exterior of the receptacle. The sidewall extends outward from an interior surface of the base. The open top is located at an outer edge of the sidewall. The cover includes an aperture, and is configured to engage the receptacle. The container is configured to accept input fluid through the cover aperture and to provide a corresponding outflow of fluid. A porous filter can be configured to be disposed within the receptacle and to receive and support the brewing material in the path of the fluid flow.

### CROSS-REFERENCE TO RELATED APPLICATIONS

This is a Continuation-in-Part of co-pending U.S. patent application Ser. No. 13/436,667, which was filed on Mar. 30, 2012; which in turn is a Continuation-In-Part of U.S. patent application Ser. No. 11/777,831, which was filed on Jul. 13, 2007, now U.S. Pat. No. 8,720,320, which issued on May 13, 2014; a Continuation-In-Part of U.S. patent application Ser. No. 12/610,181, which was filed on Oct. 30, 2009, now U.S. Pat. No. 8,621,981, which issued on Jan. 7, 2014; and a Continuation-In-Part of U.S. patent application Ser. No. 12/620,584, which was filed on Nov. 17, 2009, now U.S. Pat. No. 8,291,812, which issued on Oct. 23, 2012; which applications are incorporated herein in their entireties.

### BACKGROUND OF THE INVENTION

The present invention relates to beverage brewers and in particular to a brewing material container that can replace conventional brewing cartridges used in beverage brewers.

Beverage brewers that prepare beverages by brewing beverage material through the use of hot water are well known and in wide use. For example, coffee is prepared in a coffee maker by measuring an amount of ground coffee into a coffee filter and providing a stream of hot water through the ground coffee. In recent years, single-serving coffee makers have become very popular. For example, Keurig® coffee makers are described in U.S. Pat. Nos. 5,325,765 and 6,708,600, which disclose a housing and cooperating filter cartridge for use in the coffee maker; the disclosures of the '765 and '600 patents are incorporated herein in their entireties. The cartridges are of the single-use type—each produces a single cup of coffee, and the sealed cartridge is punctured during the brewing process and is otherwise structurally unsound after brewing and therefore cannot be reused. They are sold in sealed form and loaded with coffee-brewing material, so selection of available coffee is limited. Cartridges for brewing other beverages, such as tea, are also available, but again the selection is limited. While the housing and cartridge of these brewers are very popular, the cost of single-use cartridges exceeds the cost of the brewing material contained in the cartridges. Further, as they are not reusable and typically not recyclable, their use is quite wasteful.

### SUMMARY OF THE INVENTION

According to an aspect of the invention, a container is configured to hold brewing material while brewed by a beverage brewer. The container includes a receptacle configured to receive and support the brewing material, and a cover. The receptacle includes a receptacle sidewall, an annular lip at the bottom of the sidewall, and an open top. The sidewall defines an interior of the receptacle. The annular lip extends toward the interior of the receptacle and defines an open bottom of the receptacle. The open top is located at the outer edge of the receptacle sidewall. The cover includes an open cover aperture and is configured to sealingly engage the receptacle at the open top. The container is configured to accept input fluid through the open cover aperture and to provide a corresponding outflow of fluid through the open bottom. Thus, unlike conventional beverage containers, this aspect of the container of the invention is not sealed. Instead, the cover has an open aperture and the bottom is open.

According to another aspect of the invention, a container is configured to hold brewing material while brewed by a beverage brewer. The container includes an empty receptacle configured to receive and support the brewing material, and a cover. The receptacle includes a base, a receptacle sidewall, and an open top. The base has an interior surface and an exterior surface. The receptacle sidewall extends outward from the interior surface of the base. The open top is located at an outer edge of the receptacle sidewall. The cover includes a cover aperture and is configured to sealingly engage the receptacle at the open top. The container is configured to accept input fluid through the cover aperture and to provide a corresponding outflow of fluid. Thus, unlike conventional beverage cartridges, the receptacle of this aspect of the container of the invention does not contain beverage material. Instead, the receptacle is empty, to be filled with beverage brewing material of a user's choice.

According to another aspect of the invention, a container is configured to hold brewing material while brewed by a beverage brewer. The container includes a receptacle configured to receive and support the brewing material, and a cover. The receptacle includes a base, a receptacle sidewall, and an open top. The base has an interior surface and an exterior surface. The receptacle sidewall extends outward from the interior surface of the base. The open top is located at an outer edge of the receptacle sidewall. The cover includes a cover aperture and is configured to repeatedly removably sealingly engage the receptacle at the open top. The container is configured to accept input fluid through the cover aperture and to provide a corresponding outflow of fluid. Thus, unlike conventional beverage containers, this aspect of the container of the invention does not include a lid or upper membrane that is fixed to the top of the receptacle. Instead, the cover can be repeatedly removed and replaced, that is, coupled and uncoupled, so that the receptacle can be used more than once for brewing.

According to another aspect of the invention, a container is configured to hold brewing material while brewed by a beverage brewer. The container includes a receptacle configured to receive and support the brewing material, and a cover. The receptacle includes a base, a receptacle sidewall, and an open top. The base has an interior surface and an exterior surface. The receptacle sidewall extends outward from the interior surface of the base. The open top is located at an outer edge of the receptacle. The cover includes a cover aperture and is configured to sealingly engage the receptacle at the open top. The container is configured to accept input fluid through the cover aperture and to provide a corresponding outflow of fluid. The receptacle and the cover include materials such that the container retains structural integrity after fluid is passed through the container such that new brewing material can be added and brewed. Thus, unlike conventional beverage containers, this aspect of the container of the invention is not limited to a single use. Instead, the container is reusable and can be used to brew many beverages without the need to throw away and replace the container.

Preferably, the receptacle does not include the brewing material. Alternatively, the container can also include the brewing material, disposed within the receptacle.

The receptacle can include a base aperture that allows fluid communication from an interior of the receptacle to an exterior of the receptacle. In embodiments that include the annular lip, the lip takes the place of the base, and the corresponding open bottom acts as the base aperture. The base aperture or open bottom can have an unobstructed configuration.

The cover can include a tamping projection extending from an inner surface of the cover. The tamping projection can extend into an interior of the receptacle when the cover engages the receptacle.

Embodiments of the container having a bottom lip can also include a tamping projection that includes a contact member and a biasing member coupled to the contact member. The biasing member can be configured to couple to the annular lip and exert a force on the contact member in the direction of the open top.

The container can also include a porous filter that is configured to be disposed within the receptacle and to receive and support the brewing material in the path of the fluid flow. The porous filter can be, for example, a mesh filter, and/or can include filter paper. The porous filter can include a bottom and a filter sidewall. A lid can be attached to the filter sidewall at an upper peripheral edge.

Certain embodiments of the container have a solid base, that is, a base without an aperture or open bottom. In this case, or in addition to the base aperture or open bottom, the sidewall can include one or more sidewall apertures that allow fluid communication from an interior of the receptacle to an exterior of the receptacle. The sidewall aperture can include a mesh panel.

According to another aspect of the invention, a beverage brewer includes a brewing chamber, the container according to an aspect of the invention, disposed within the brewing chamber, and an inlet port, configured to provide the input fluid to the container.

### BRIEF DESCRIPTION OF THE DRAWINGS

FIG. 1 shows a prior art housing of a conventional single-serving beverage brewer, with a conventional brewing material cartridge residing in the housing.

FIG. 2 is a perspective view of an exemplary beverage brewing container according to the present invention.

FIG. 3 is a cross-sectional side view of an exemplary beverage brewing container containing brewing material in mesh filter material and having an annular recess in the bottom of the receptacle, according to the present invention.

FIG. 4 is a cross-sectional side view of an exemplary beverage brewing container according to the present invention in the conventional single-serving beverage brewer housing.

FIG. 5A shows a cross-sectional side view of an exemplary tamping brewing material container having an annular recess in the bottom of the receptacle, according to the present invention.

FIG. 5B shows a cross-sectional side view of an exemplary tamping brewing material container with the cover engaging the receptacle, according to the present invention.

FIG. 6 is a cross-sectional side view of an exemplary beverage brewing container containing brewing material and having an annular recess in the bottom of the receptacle, according to the present invention.

FIG. 7 is a cross-sectional side view of an exemplary beverage brewing container according to the present invention while in a conventional single-serving beverage brewer housing.

FIG. 8 is a cross-sectional side view of an exemplary beverage brewing container containing brewing material and having an offset recess in the bottom of the receptacle, according to the present invention.

FIG. 8A is a cross-sectional plan view of the receptacle of FIG. 8 taken along line 8A-8A.

FIG. 9 is a cross-sectional side view of an exemplary beverage brewing container according to the present invention while in conventional single-serving beverage brewer housing.

### DETAILED DESCRIPTION OF THE INVENTION

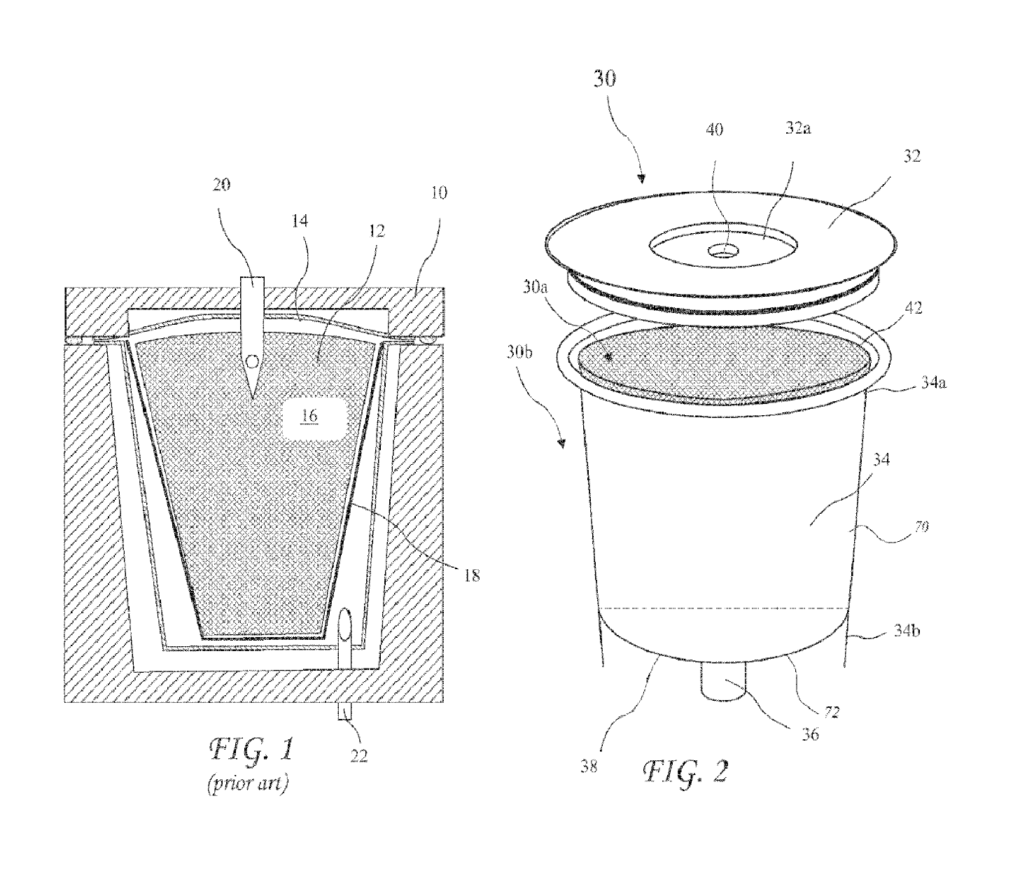

A conventional single-serving beverage brewer housing 10 and single-use filter cartridge 12 as disclosed in U.S. Pat. Nos. 5,325,765 and 6,708,600 are shown in FIG. 1. The sealed brewing material cartridge 12 includes a pierceable shell 14 and contains brewing material 16 within a filter 18. An upper tubular needle 20 penetrates the top of the shell 14 and an offset lower tubular needle 22 penetrates the bottom of the shell 14 when the housing 10 is closed on the cartridge 12. Hot water enters the shell 14 through the upper tubular needle 20 and brews the beverage by passing through the brewing material 16, and the brewed beverage exits the shell 14 via the lower tubular needle 22, which delivers the brewed beverage to a mug or other vessel.

A perspective view of an exemplary beverage container 30 according to the present invention is shown in FIG. 2. The beverage container 30 includes a cover 32 and a receptacle 34. The receptacle 34 includes a top end 34a and a bottom end 34b. This embodiment as shown is generally frustoconical in shape, although the receptacle according to the invention is not restricted to this or any other shape. An aperture 40 in the cover 32 is provided for the needle 20 or for any implement that would provide an inflow of liquid. The bottom end 34b of the receptacle 34 includes an annular recessed region 38 surrounding a stem 36 generally centered in the bottom end 34b of the receptacle 34. The stem 36 extends downward in the bottom end 34b of the receptacle 34. The cover 32 can be removably coupleable to the receptacle 34, or hingedly attached and coupleable to the receptacle 34. The cover 32 can have an interference coupling fit to the receptacle 34, or the cover 32 and receptacle 34 can have cooperating threads to threadably couple, or the cover 32 can be otherwise coupled to the receptacle 34. The beverage container 30 defines an interior region 30a and an exterior region 30b and a mesh fitter 42 can be disposed in the receptacle 34 to restrain brewing material within the interior region 30a.

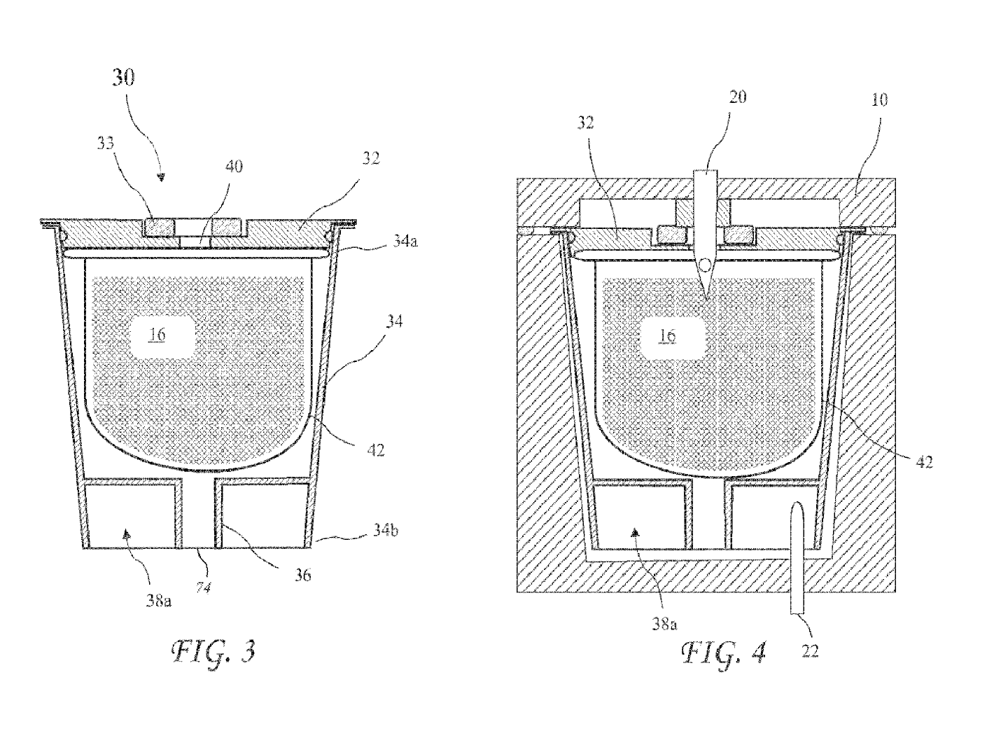

A cross-sectional side view of the beverage container 30 containing brewing material 16 restrained in the receptacle 34 by the mesh filter material 42 and having an annular recess 38a in the bottom of the receptacle 34 is shown in FIG. 3, and a cross-sectional side view of the beverage container 30 while disposed in the conventional beverage cartridge housing 10 is shown in FIG. 4. The mesh filter 42 holds the brewing material 16, and retains the brewing material 16 in the interior region 30a of the beverage container 30. The mesh filter 42 can be a fixed filter not removable from the receptacle 34 or can be a removable filter, and can be constructed of nylon mesh or metal mesh, or any material capable of holding the brewing material while allowing a flow of fluid through the brewing material. Filter paper can be used as the mesh filter 42, but it is preferred that the mesh filter 42 is a material that can be cleaned and reused. The needle 20 extends through the passage 40 in the cover 32 to inject hot liquid into the brewing material 16 to make a brewed beverage. The annular recess 38a provides clearance for the lower needle 22 of the beverage maker without requiring aligning the annular recessed area 38a with the offset bottom needle 22. A compliant ring 33 can be included in the cover to seal against the beverage maker upper needle 20.

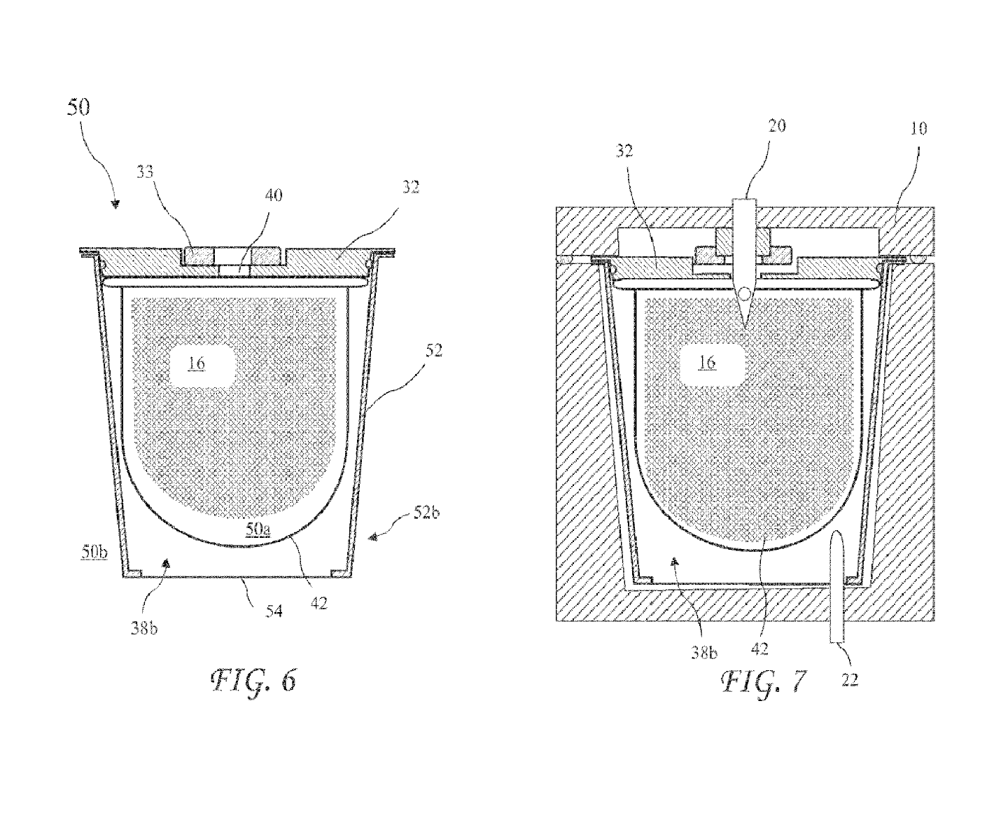

Thus, in general, the container 30 of the invention is configured to hold brewing material while brewed by a beverage brewer. The container 50 includes a receptacle 34 that receives and supports the brewing material 16 and a cover 32. As shown, the receptacle 34 includes a base 72, a sidewall 70, and an open top. The base 72 has an open base aperture 74, that is, an aperture that is an open space, a void in the surface of the base 72, with no means of closure; thus, the receptacle is not sealed, and the aperture 74 is not formed by piercing or otherwise penetrating a formerly sealed structure or membrane. The base aperture 74 allows fluid communication from an interior of the receptacle 34 to an exterior of the receptacle 34, and can be of any size. For example, as shown in FIGS. 6 and 7, the base can be just a lip extending inward from the sidewall and the base aperture 54 can be large enough to open up most of the bottom of the receptacle 52. Alternatively, the aperture can be smaller, as shown in the other drawings in connection with the description of other embodiments. As described above, the aperture 74 can open into a stem 36. Preferably, the base aperture 74 is unobstructed, that is, provides a clear path for the brewed beverage or other liquid passing through the aperture 74. Alternatively, the aperture 74 can have a serpentine path and/or can include baffles in order to froth or otherwise affect the quality or condition of the beverage.

In alternative embodiments, the base aperture 74 need not be open. Instead, the aperture 74 can be covered, such as by a plate that is hingedly or otherwise attached to the base or end of the stem. This plate can be biased in a closed direction, which bias can be overcome, for example, by pressure from impinging liquid within the receptacle that opens the plate and allows the liquid to flow out. Alternatively, the aperture 74 can be a small hole covered by a resilient flexible flap or other cover that can be pushed aside by the needle-like projection or tube 22 that forms part of the beverage brewer. The flap can function like a valve, preventing fluid flow through the aperture 74 until pushed open by the tube 22.

Alternatively, the base need not have an aperture at all, and can be solid with no fluid passage. Instead of, or in addition to, a base aperture, the sidewall can include one or more apertures. Such a sidewall aperture can be open, or can include mesh, such as by being formed as a mesh opening, or by being partially or completely covered by a mesh material.

As shown, the sidewall 70 extends outward, in this orientation upward, from the interior surface of the base 72. The container 30 can have multiple sidewalls, but only a simple embodiment including a single sidewall 70 is shown. The open top is located at the outer (upper) edge of the receptacle sidewall 70. The edge of the sidewall itself can define the periphery of the open top, or the sidewall 70 can include inner and/or outer lips at or near the top of the sidewall 70. The cover 32 includes a cover aperture 40. As with the base aperture, the cover aperture 40 preferable is open, that is, the receptacle 34 is not sealed when the cover 32 is in place, and the aperture 40 is not formed by piercing or otherwise penetrating a formerly sealed structure or membrane. However, the cover 32 is configured to sealingly engage the receptacle 34 at the open top. That is, a seal is formed where the cover 32 meets the receptacle 34 at or near the open top, to prevent liquid from leaking out. The seal can be provided, for example, by a rubber ring held in a groove in a surface of the cover 32 that engages the receptacle 34 when the cover 32 is coupled to the receptacle 34. As configured, the container 30 accepts input fluid through the open cover aperture 40 and provides a corresponding outflow of fluid through the open base aperture 74.

As with the base aperture 74, the cover aperture 40 need not be open. Instead, the aperture 40 can be covered, such as by a plate that is hingedly or otherwise attached to the base. This plate can be biased in a closed direction, which bias can be overcome, for example, by pressure from impinging liquid or a tube that is part of the beverage brewer and that provides the liquid, such as the upper tubular needle 20. Alternatively, the aperture 40 can be a small hole covered by a resilient flexible flap or other cover that can be pushed aside by the needle 20. The aperture cover can function like a valve, preventing fluid flow through the aperture 40 until pushed open by the tubular needle 20.

The mesh filter 42 can be made of or include metal, plastic, nylon, or any other material or combination of materials that can support the brewing material and can withstand the pressure and heat of the water or other liquid used to brew the beverage. The filter 42, however, need not be mesh, and can be made from any porous filter material, such as filter paper, that is configured to be disposed within the receptacle and to receive and support the brewing material in the path of the fluid flow. The porous filter 42 can be a formless sheet, or can be a formed structure, which can include a bottom and a filter sidewall. In some embodiments, the filter 42 can include a lid, which can be hingedly attached to the filter sidewall, for example, at an upper edge.

In contrast to conventional beverage brewing cartridges, the container 30 of the invention preferably is reusable. To this end, the receptacle 34 and the cover 32 can include materials such that the container 30 retains structural integrity after fluid, even very hot fluid, is passed through the container 30. Unlike the conventional cartridge, neither the cover 32 nor the receptacle base 72 is pierced, punctured, or otherwise damaged or altered in the brewing process, and the cover 32 can be repeatedly removed from and recoupled to the receptacle 34, making it possible for new brewing material to be added and brewed numerous times using the same container 30. In some embodiments, the filter 42 is reusable, such as when it is made from a durable mesh material. In other embodiments, the filter 42 can be disposable, such as when filter paper is used as the filter material.

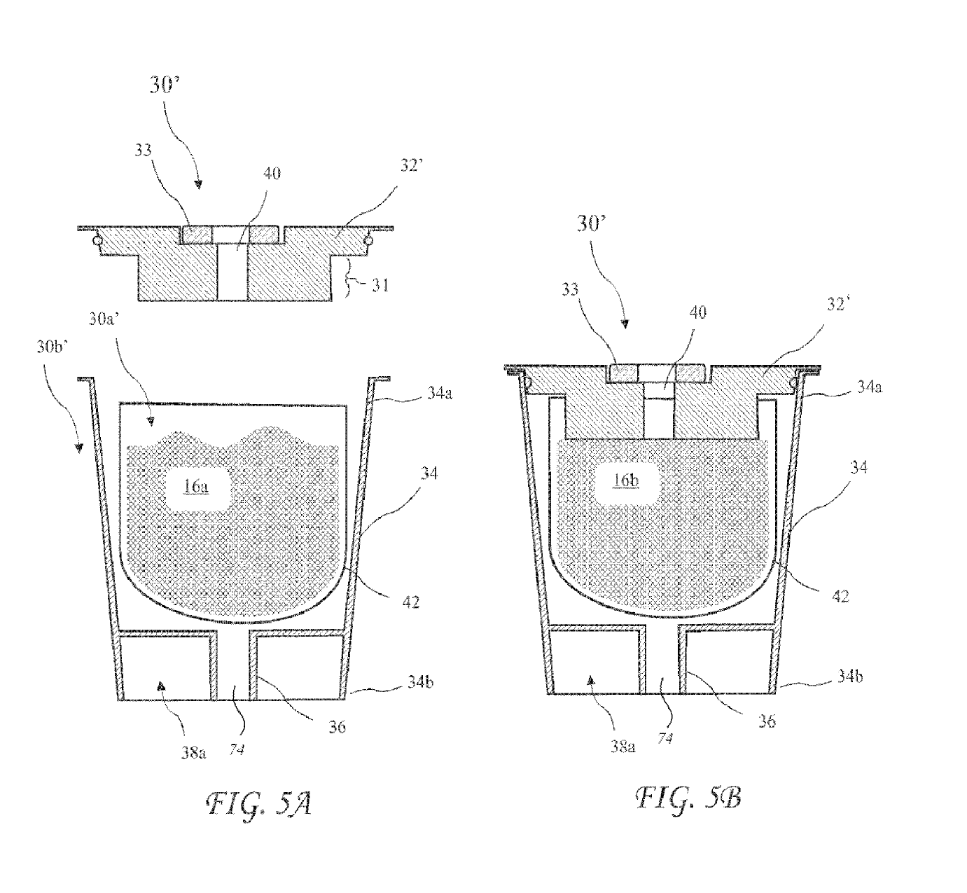

A cross-sectional view of a tamping container 30′ having a cover 32′ including a tamping projection or tamper 31, is shown in FIG. 5A, and a cross-sectional view of the tamping container 30′ with the cover 32′ coupled to the receptacle 34 is shown in FIG. 5B. When the cover 32′ is coupled to the receptacle 34, the tamper 31 extends into the receptacle 34 to tamp brewing material 16a held in the receptacle 34 by the mesh filter material 42. Tamping the brewing material can reduce or prevent channeling and generally affect the quality and/or condition of the resulting brewed beverage. The container 30′ is otherwise similar to the container 30 described above.

In alternative embodiments, the tamping projection can include a contact member, such as a rigid plate, and a biasing member, such as a spring. The biasing member can be coupled to the cover at a first end and to the contact member at a second end. In this configuration, the biasing member can exert a force on the contact member directed away from the cover, causing the tamping projection to push against the brewing material when the brewing material is supported within the receptacle and the cover is engaged with the receptacle. Alternatively, the tamper can push toward the brewing material held within the receptacle from the direction of the receptacle base. For example, the biasing member can be attached to the inner surface of the base and/or the inner surface of the sidewall, such that it causes the contact member to push toward the cover, effectively tamping the brewing material in the receptacle from the direction of the base toward the cover.

A cross-sectional side view of another exemplary embodiment of the container 50 is shown in FIG. 6, and a cross-sectional side view of this container 50 while disposed in the conventional beverage brewer housing 10 is shown in FIG. 7. The container 50 includes the cover 32 and a receptacle 52. The brewing material 16 is held in the receptacle 52 by the mesh filter material 42.

The container 50 defines an interior region 50a and an exterior region 50b (similar to the regions 30a and 30b shown in FIG. 2). The beverage filter 42 holds the brewing material 16, and retains the brewing material 16 in the interior region 50a of the container 50. The needle 20 extends through the aperture 40 in the cover 32 to inject hot liquid into the brewing material 16 to make a brewed beverage. A large base aperture 54 in the bottom end 52b of the receptacle 52 provides clearance for the lower needle 22. In the embodiment shown in FIG. 6, the base aperture 54 occupies the majority of the bottom plane of the receptacle 52, allowing for the free flow of brewed beverage out of the receptacle 52.

In the most extreme embodiment, the entire bottom of the receptacle 52 can be the base aperture 54. That is, the base itself can be absent, and the bottom end 52b of the receptacle 52 can be open at the bottom end. In a less extreme embodiment, the bottom end 52b of the receptacle 54 can include an inner lip instead of a base, as shown in FIG. 6. This inner lip can provide a surface, for example, on which the biasing member of the tamping projection described above can be coupled or attached. The container 50 is otherwise similar to the container 30 described above. This embodiment is also suitable for use in beverage brewers that do not use a lower needle, or in which the lower needle is pushed aside, and instead allow for the free flow of brewed beverage into a large container below, such as a carafe used in a multi-serving beverage brewing system.

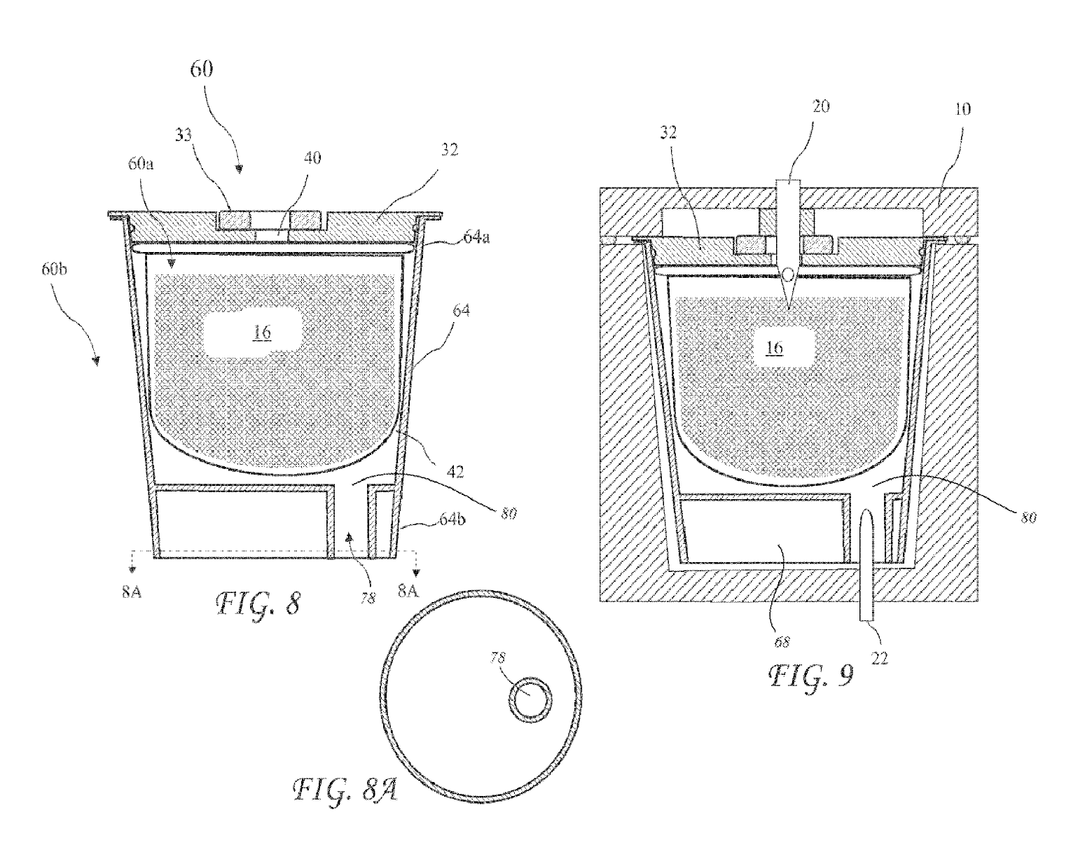

A cross-sectional side view of another exemplary embodiment of the container 60 is shown in FIG. 8, a cross-sectional view of the receptacle 64 taken along line 8A-8A of FIG. 8 is shown in FIG. 8A, and a cross-sectional side view of the container 60 while disposed in the conventional beverage brewer housing 10 is shown in FIG. 9. An offset recess 68 in the base 64b of the receptacle 64 provides clearance for the length of the lower needle 22, and a passage 78 within a stem extends outward from the base 64b from the base aperture and provides clearance around the lower needle 22. While the offset recess 68 is shown as having a round cross-section, the offset recess 68 may have any cross-section suitable to provide clearance for the needle 22. As shown, the lower needle does not puncture or even touch the receptacle 64, and does not reach the filter 42. The container 60 is otherwise similar to the container 30 described above.

Particular exemplary embodiments of the present invention have been described in detail. These exemplary embodiments are illustrative of the inventive concept recited in the appended claims, and are not limiting of the scope or spirit of the present invention as contemplated by the inventor.

I claim:

1. A container, configured to hold brewing material while brewed by a beverage brewer, comprising:
a receptacle configured to receive and support the brewing material; and
a cover;
wherein the receptacle includes
a receptacle sidewall defining an interior surface of the receptacle,
an annular lip at the bottom of the receptacle sidewall, extending toward the interior of the receptacle and defining an open bottom of the receptacle, and
an open top at an outer edge of the receptacle sidewall;
wherein the cover includes
an open cover aperture,
wherein the cover is configured to sealingly engage the receptacle at the open top; and
wherein the container is configured to accept input fluid through the open cover aperture and to provide a corresponding outflow of fluid through the open bottom.

2. The container of claim 1, wherein the receptacle and the cover include materials such that the container retains structural integrity after fluid is passed through the container such that new brewing material can be added and brewed.

3. The container of claim 1, wherein the cover is configured to repeatedly removably engage the receptacle at the open top.

4. The container of claim 1, wherein the container does not include the brewing material.

5. The container of claim 1, further including the brewing material, disposed within the receptacle.

6. The container of claim 1, wherein the open bottom has an unobstructed configuration.

7. The container of claim 1, further comprising a tamping projection that includes a contact member and a biasing member coupled to the contact member, wherein the biasing member is configured to couple to the annular lip and exert a force on the contact member in the direction of the open top.

8. The container of claim 1, further comprising a porous filter configured to be disposed within the receptacle and to receive and support the brewing material in the path of the fluid flow.

9. The container of claim 8, wherein the porous filter is a mesh filter.

10. The container of claim 8, wherein the porous filter includes filter paper.

11. The container of claim 8, wherein the porous filter includes a bottom and a filter sidewall.

12. The container of claim 11, wherein the porous filter further includes a lid that is attached to the filter sidewall.

13. A beverage brewer, comprising:
a brewing chamber,
the container of claim 1, disposed within the brewing chamber; and
an inlet port, configured to provide the input fluid to the container.

14. A container, configured to hold brewing material while brewed by a beverage brewer, comprising:
a receptacle configured to receive and support the brewing material; and
a cover;
wherein the receptacle includes
a base, including an interior surface and an exterior surface,
a receptacle sidewall extending outward from the interior surface of the base, and
an open top at an outer edge of the receptacle sidewall;
wherein the cover includes
a cover aperture,
wherein the cover is configured to repeatedly removably sealingly engage the receptacle at the open top; and
wherein the container is configured to accept input fluid through the cover aperture and to provide a corresponding outflow of fluid.

15. The container of claim 14, wherein the receptacle and the cover include materials such that the container retains structural integrity after fluid is passed through the container such that new brewing material can be added and brewed.

16. The container of claim 14, wherein the cover aperture is open.

17. The container of claim 14, wherein the cover further includes a tamping projection that is configured to extend into an interior of the receptacle when the cover engages the receptacle.

18. The container of claim 14, wherein the base also includes a base aperture that allows fluid communication from an interior of the receptacle to an exterior of the receptacle.

19. The container of claim 18, wherein the base aperture is open.

20. The container of claim 18, wherein the base aperture has an unobstructed configuration.

21. The container of claim 14, wherein the base is an annular lip at the bottom of the receptacle sidewall, extending toward the interior of the receptacle and defining an open bottom of the receptacle.

22. The container of claim 21, further comprising a tamping projection that includes a contact member and a biasing member coupled to the contact member, wherein the biasing member is configured to couple to the annular lip and exert a force on the contact member in the direction of the open top.

23. The container of claim 14, further comprising a porous filter configured to be disposed within the receptacle and to receive and support the brewing material in the path of the fluid flow.

24. The container of claim 23, wherein the porous filter is a mesh filter.

25. The container of claim 23, wherein the porous filter includes filter paper.

26. The container of claim 23, wherein the porous filter includes a bottom and a filter sidewall.

27. The container of claim 26, wherein the porous filter further includes a lid that is attached to the filter sidewall.

28. The container of claim 14, wherein the sidewall includes a sidewall aperture that allows fluid communication from an interior of the receptacle to an exterior of the receptacle.

29. The container of claim 28, wherein the sidewall aperture includes a mesh panel.

30. A beverage brewer, comprising:
a brewing chamber;
the container of claim 14, disposed within the brewing chamber;
an inlet port, configured to provide the input fluid to the container.

31. A container, configured to hold brewing material while brewed by a beverage brewer, comprising:
an empty receptacle configured to receive and support the brewing material; and
a cover;
wherein the receptacle includes
a base, including an interior surface and an exterior surface,
a receptacle sidewall extending outward from the interior surface of the base, and
an open top at an outer edge of the receptacle sidewall;
wherein the cover includes
a cover aperture,
wherein the cover is configured to sealingly engage the receptacle at the open top; and
wherein the container is configured to accept input fluid through the cover aperture and to provide a corresponding outflow of fluid through the base aperture.

32. The container of claim 31, wherein the receptacle and the cover include materials such that the container retains structural integrity after fluid is passed through the container such that new brewing material can be added and brewed.

33. The container of claim 31, wherein the cover aperture is open.

34. The container of claim 31, wherein the base also includes a base aperture that allows fluid communication from an interior of the receptacle to an exterior of the receptacle.

35. The container of claim 31, wherein the base aperture is open.

36. The container of claim 31, wherein the base aperture has an unobstructed configuration.

37. The container of claim 31, wherein the base is an annular lip at the bottom of the receptacle sidewall, extending toward the interior of the receptacle and defining an open bottom of the receptacle.

38. The container of claim 37, further comprising a tamping projection that includes a contact member and a biasing member coupled to the contact member, wherein the biasing member is configured to couple to the annular lip and exert a force on the contact member in the direction of the open top.

39. The container of claim 31, further comprising a porous filter configured to be disposed within the receptacle and to receive and support the brewing material in the path of the fluid flow.

40. The container of claim 31, wherein the porous filter is a mesh filter.

41. The container of claim 31, wherein the porous filter includes filter paper.

42. The container of claim 31, wherein the porous filter includes a bottom and a filter sidewall.

43. The container of claim 42, wherein the porous filter further includes a lid that is attached to the filter sidewall.

44. The container of claim 31, wherein the sidewall includes a sidewall aperture that allows fluid communication from an interior of the receptacle to an exterior of the receptacle.

45. The container of claim 44, wherein the sidewall aperture includes a mesh panel.

46. A beverage brewer, comprising:
a brewing chamber;
the container of claim 31, disposed within the brewing chamber;
an inlet port, configured to provide the input fluid to the container; and
a tube, configured to receive the outflow fluid from the container;
wherein the base aperture is configured to receive the tube and to provide a clearance around the tube such that the tube does not touch the base.

47. A container, configured to hold brewing material while brewed by a beverage brewer, comprising:
a receptacle configured to receive and support the brewing material;
a porous filter; and
a cover;
wherein the receptacle includes
a base, having an interior surface, an exterior surface, and a base aperture, wherein the base aperture allows fluid communication from an interior of the receptacle to an exterior of the receptacle,
a receptacle sidewall extending outward from the interior surface of the base, and
an open top at an outer edge of the receptacle sidewall;
wherein the cover includes
a cover aperture,
wherein the cover is configured to sealingly engage the receptacle at the open top; and
wherein the container is configured to accept input fluid through the cover aperture and to provide a corresponding outflow of fluid through the base aperture;
wherein the porous filter is configured to be disposed within the receptacle and to receive and support the brewing material in the path of the fluid flow; and
wherein the receptacle and the cover include materials such that the container retains structural integrity after fluid is passed through the container such that new brewing material can be added and brewed.

48. The container of claim 47, wherein the cover aperture is open.

49. The container of claim 47, wherein the base also includes a base aperture that allows fluid communication from an interior of the receptacle to an exterior of the receptacle.

50. The container of claim 47, wherein the base aperture is open.

51. The container of claim 47, wherein the base aperture has an unobstructed configuration.

52. The container of claim 47, wherein the base is an annular lip at the bottom of the receptacle sidewall, extending toward the interior of the receptacle and defining an open bottom of the receptacle.

53. The container of claim 52, further comprising a tamping projection that includes a contact member and a biasing member coupled to the contact member, wherein the biasing member is configured to couple to the annular lip and exert a force on the contact member in the direction of the open top.

54. The container of claim 47, further comprising a porous filter configured to be disposed within the receptacle and to receive and support the brewing material in the path of the fluid flow.

55. The container of claim 54, wherein the porous filter is a mesh filter.

56. The container of claim 54, wherein the porous filter includes filter paper.

57. The container of claim 54, wherein the porous filter includes a bottom and a filter sidewall.

58. The container of claim 57, wherein the porous filter further includes a lid that is attached to the filter sidewall.

59. The container of claim 47, wherein the sidewall includes a sidewall aperture that allows fluid communication from an interior of the receptacle to an exterior of the receptacle.

60. The container of claim 59, wherein the sidewall aperture includes a mesh panel.

61. A beverage brewer, comprising:
a brewing chamber;
the container of claim 47, disposed within the brewing chamber; and
an inlet port, configured to provide the input fluid to the container.
